(19) United States
(12) Patent Application Publication
(10) Pub. No.: US 2011/0014475 A1
(43) Pub. Date: Jan. 20, 2011

(54) REINFORCED GLASS, REINFORCED GLASS SUBSTRATE, AND METHOD FOR PRODUCING THE SAME

(76) Inventor: Takashi Murata, Shiga (JP)

Correspondence Address: WENDEROTH, LIND & PONACK, L.L.P., 1030 15th Street, N.W.,, Suite 400 East, Washington, DC, 20005-1503, US

(21) Appl. No.: 12/677,178

(22) PCT Filed: Sep. 18, 2008
(86) PCT No.: PCT/JP2008/066877

§ 371 Date: Mar. 9, 2010

(30) Foreign Application Priority Data
Sep. 27, 2007 (JP) 2007-252589

(51) Int. Cl. B32B 17/00; C03C 3/083; C03C 3/085; C03C 3/091; C03C 3/087; C03C 21/00; C03B 27/00

(52) U.S. Cl. 428/410; 501/68; 501/69; 501/66; 501/70; 65/30.14

(57) ABSTRACT

Provided is a tempered glass, which has a compressive stress layer on a surface thereof, comprising, in terms of mol %, 40 to 80% of SiO₂, 5 to 15% of Al₂O₃, 0 to 8% of B₂O₃, 0 to 10% of Li₂O, 5 to 20% of Na₂O, 0.5 to 20% of K₂O, 0 to 10% of MgO, and 8 to 16.5% of Al₂O₃+MgO, wherein the glass has, in terms of a molar ratio, a (Li₂O+Na₂O+K₂O)/Al₂O₃ ratio of 1.4 to 3, an Na₂O/Al₂O₃ ratio of 1 to 3, and an MgO/Al₂O₃ ratio of 0 to 1, and is substantially free of As₂O₃, PbO, and F.

### TECHNICAL FIELD

The present invention relates to a tempered glass substrate, in particular, a tempered glass substrate suitable for a cover glass of a cellular phone, digital camera, a personal digital assistance (PDA), or a solar cell, or a touch panel display.

### BACKGROUND ART

Devices such as cellular phones, digital cameras, PDA, and touch panel displays show a tendency of further prevalence.

Conventionally, for those applications, resins made of acrylic and the like were used as a protective member for protecting a display. However, an acrylic resin substrate was bended because of low Young's modulus of an acrylic resin, when a display was pushed with a human finger and the like, and thus, the acrylic resin substrate came into touch with a display to generate poor display, in some cases. There was also a problem in that flaw was easily formed on the acrylic resin substrate, and visibility tended to deteriorate. One method of solving those problems is to use a glass substrate as a protective member. The glass substrate to be used as those protective members is required (1) to have high mechanical strength, (2) to be low in density, (3) to be cheap and to be supplied in a large amount, and (4) to have excellent bubble quality. In order to satisfy the requirement (1), glass substrates tempered by ion exchange and the like (so-called tempered glass substrate) are conventionally used (see Patent Document 1, Non-Patent Document 1).
Patent Document 1: JP 2006-83045 A
Non-Patent Document 1: Tetsuro Izumitani et al., “New glass and physicality thereof”, First edition, Management System Laboratory. Co., Ltd., Aug. 20, 1984, p. 451-498

### DISCLOSURE OF THE INVENTION

### Problems to be Solved by the Invention

Non-Patent document 1 describes that when the content of Al₂O₃ in the glass composition is increased, the ion exchange performance of glass increases and the mechanical strength of a glass substrate can be improved.

However, when the content of Al₂O₃ in the glass composition is further increased, the devitrification resistance of the glass deteriorates, so that the glass tends to be devitrified during forming, therefore the production efficiency, quality, and the like of the glass substrate become worse. When the devitrification resistance of the glass is poor, forming is only possible by a method such as roll forming, therefore a glass plate having high surface precision cannot be obtained. Thus, after forming of the glass plate, a polishing process should be additionally performed separately. When the glass substrate is polished, however, small defects tend to be generated on the surface of the glass substrate, and it becomes difficult to maintain the mechanical strength of the glass substrate.

In view of the above circumstances, it is difficult to attain the ion exchange performance and the denitrification resistance of a glass simultaneously, and it is difficult to remarkably improve the mechanical strength of the glass substrate. For reducing the weight of a device, glass substrates used in devices such as touch panel displays are reduced in thickness year by year. Because a glass substrate with small thickness is easily broken, technologies for improving the mechanical strength of the glass substrate are becoming more important.

Further, even if an ion exchange treatment is performed to a glass to thereby form a high compression stress value on a surface of the glass, the glass may be broken at a lower stress than the compression stress value in some cases, and as a result, a variation in strength may increase. The smallness in depth of the compression stress layer is considered to be the reason. Therefore, it is desired that the depth of the compression stress layer be increased, however, when the thickness of the compression stress layer is increased, an ion exchange treatment time becomes longer or a decrease in the compression stress value easily occurs. In addition, as a method of reducing the variation in strength, there is known a method involving treating glass with a KNO₃ solution, and then additionally treating the glass with a NaNO₃ solution. However, there is a problem that the method also requires a long treatment time, resulting in high cost.

Consequently, technical object of the present invention is to make an ion exchange performance and devitrification resistance of glass compatible so as to increase the depth of a compression stress layer even when an ion exchange treatment is performed in a relatively short period of time, thereby to obtain a tempered glass having high mechanical strength and excellent formability.

### Means for solving the Problems

The inventors of the present invention have conducted various studies and consequently found that limiting the ratio of Al₂O₃ and MgO in glass can improve the ion exchange performance and devitrification resistance. The inventors have also found that limiting the ratio of Al₂O₃ and alkali metal oxides can improve the devitrification resistance. The inventors have also found that containing a predetermined amount of K₂O can increase the depth of the compression stress layer. The inventors have also found that limiting the ratio of K₂O and Na₂O can increase the depth of the compression stress layer without decreasing the compression stress value, and thus, leading to the proposal of the present invention.

That is, a tempered glass of the present invention is characterized in that the tempered glass has a compression stress layer on a surface thereof, comprises, in terms of mol %, 40 to 80% of SiO₂, 5 to 15% of Al₂O₃, 0 to 8% of B₂O₃, 0 to 10% of Li₂O, 5 to 20% of Na₂O, 0.5 to 20% of K₂O, 0 to 10% of MgO, and 8 to 16.5% of Al₂O₃+MgO, wherein the glass has, in terms of a molar ratio, a (Li₂O+Na₂O+K₂O)/Al₂O₃ ratio of 1.4 to 3, an Na₂O/Al₂O₃ ratio of 1 to 3, and an MgO/Al₂O₃ ratio of 0 to 1, and is substantially free of As₂O₃, PbO, and F. It should be noted that, unless otherwise noted, “%” means mol % in the following descriptions.

Further, the tempered glass of the present invention is characterized in that the tempered glass has a compression stress layer on a surface thereof, comprises, in terms of mol %, 45 to 80% of SiO₂, 8 to 11% of Al₂O₃, 0 to 5% of B₂O₃, 0 to 10% of Li₂O, 5 to 20% of Na₂O, 0.5 to 8% of K₂O, 0 to 6% of CaO, 0 to 6% of MgO, 8 to 16.5% of Al₂O₃+MgO, and 0 to 7% of CaO+MgO, wherein the glass has, in terms of a molar ratio, a (Li₂O+Na₂O+K₂O)/Al₂O₃ ratio of 1.4 to 3, an Na₂O/Al₂O₃ ratio of 1 to 3, an MgO/Al₂O₃ ratio of 0 to 1, and a K₂O/Na₂O ratio of 0.1 to 0.8, and is substantially free of As₂O₃, PbO, and F.

Further, the tempered glass of the present invention may include 0.01 to 6% of SnO₂.

Further, the tempered glass of the present invention may have an average breaking stress of 300 MPa or more and a Weibull coefficient of 15 or more. Here, “average breaking stress” denotes an average value of a breaking stress calculated from a breaking load obtained by performing a three-point bending test using a glass test piece having a dimension of 3 mm×4 mm×40 mm, the entire surface of the glass test piece being optically polished. Further, “Weibull coefficient” denotes an inclination of an approximate straight line obtained by Weibull-plotting the breaking stress using an average value ranking method.

Further, the tempered glass substrate of the present invention may have a compression stress of the surface of 300 MPa or more and a depth of the compression stress layer of 10 μm or more. Here, “compression stress of surface” and “depth of compression stress layer” denote values calculated from the number of interference stripes and interval therebetween obtained in observing a sample using a surface stress meter (FSM-6000 manufactured by Toshiba Corporation).

Further, the tempered glass substrate of the present invention may include the tempered glass.

Further, the tempered glass substrate of the present invention may be formed into a plate shape by an overflow down-draw method.

Further, the tempered glass substrate of the present invention may have an unpolished surface. Here, “unpolished surface” means that main surfaces (so-called front surface and rear surface) of a glass substrate are not polished. In other words, it means that both surfaces are fire-polishing surfaces, and by this, it becomes possible to decrease the average surface roughness (Ra). When the average surface roughness (Ra) is measured by a method according to SEMI D7-97 “Measurement method of surface roughness of FPD glass substrate”, the average surface roughness (Ra) is 10 Å or less, preferably 5 Å or less, and more preferably 2 Å or less. Note that an end surface of the glass substrate may be subjected to a polishing treatment such as chamfering.

Further, the tempered glass substrate of the present invention may have a liquidus temperature of 1,075° C. or lower. Here, a glass is ground into powder, and a glass powder passing through a standard sieve of 30 mesh (mesh opening 500 μm) and remaining on 50 mesh (mesh opening 300 μm) is placed in a platinum boat, and is kept in a temperature gradient furnace for 24 hours, and then, the crystal thereof deposits. The temperature at this stage is referred to as “liquidus temperature”.

Further, the tempered glass substrate of the present invention is characterized by having a liquidus viscosity of 10^{4.0} dPa·s or more. Here, “liquidus viscosity” denotes the viscosity of a glass at the liquidus temperature. When the liquidus viscosity is higher and the liquidus temperature is lower, the denitrification resistance of a glass is improved, and the formability of a glass substrate is improved.

Further, the tempered glass substrate of the present invention can be used for a touch panel display.

Further, the tempered glass substrate of the present invention can be used for a cover glass of a cellular phone.

Further, the tempered glass substrate of the present invention can be used for a cover glass of a solar cell.

Further, the tempered glass substrate of the present invention can be used as a protective member for a display.

Further, the glass of the present invention is characterized by comprising, in terms of mol %, 40 to 80% of SiO₂, 5 to 15% of Al₂O₃, 0 to 8% of B₂O₃, 0 to 10% of Li₂O, 5 to 20% of Na₂O, 0.5 to 20% of K₂O, 0 to 10% of MgO, and 8 to 16.5% of Al₂O₃+MgO, wherein the glass has, in terms of a molar ratio, a (Li₂O+Na₂O+K₂O)/Al₂O₃ ratio of 1.4 to 3, an Na₂O/Al₂O₃ ratio of 1 to 3, and an MgO/Al₂O₃ ratio of 0 to 1, and is substantially free of As₂O₃, PbO, and F.

Further, the glass of the present invention may include 0.01 to 6% of SnO₂.

Further, the method of producing a tempered glass substrate of the present invention is characterized by comprising the steps of: melting a glass raw material blended so as to have a glass composition comprising, in terms of mol %, 40 to 80% of SiO₂, 5 to 15% of Al₂O₃, 0 to 8% of B₂O₃, 0 to 10% of Li₂O, 5 to 20% of Na₂O, 0.5 to 20% of K₂O, 0 to 10% of MgO, and 8 to 16.5% of Al₂O₃+MgO, wherein the glass has, in terms of a molar ratio, a (Li₂O+Na₂O+K₂O) /Al₂O₃ ratio of 1.4 to 3, an Na₂O/Al₂O₃ ratio of 1 to 3, and an MgO/Al₂O₃ ratio of 0 to 1, and is substantially free of As₂O₃, PbO, and F; forming the glass into a plate shape; and subjecting the glass to an ion exchange treatment, to thereby form a compression stress layer on a surface of the glass.

Further, the glass composition may include 0.01 to 6% of SnO₂.

Further, the glass may be formed into a plate shape by a down-draw method.

Further, the method of producing a tempered glass substrate of the present invention is characterized in that the glass is formed into a plate shape by an overflow down-draw method.

### Effects of the Invention

The tempered glass of the present invention has a high ion exchange performance, and a high compression stress is formed to a deeper degree even when treatment is performed in a short period of time, and hence, mechanical strength is enhanced and the variation in mechanical strength is decreased.

Further, because the tempered glass of the present invention has excellent in denitrification resistance, an overflow down-draw method or the like can be employed. Therefore, polishing after forming is unnecessary, and small defects caused by polishing are not present. As a result, there is an effect that mechanical strength is high.

Still further, the tempered glass of the present invention can be produced without performing a polishing process, and hence, a production cost can be reduced and the glass can be supplied at low cost.

Thus, the tempered glass substrate of the present invention can be suitably used for a touch panel display, a cover glass of a cellular phone, a cover glass of a solar cell, a protective member of a display, or the like. It should be noted that a touch panel display is mounted on a cellular phone, a digital camera, PDA, and the like. Weight reduction, thickness reduction, and highly tempering in a touch panel display for mobile application are highly demanded, and hence, there is required a thin glass substrate having high mechanical strength. In this respect, the tempered glass substrate of the present invention is suitable for mobile application, because even if the plate thickness thereof is reduced, the substrate has practically sufficient mechanical strength.

Further, the glass of the present invention has a high ion exchange performance and excellent denitrification resistance, and hence, the glass can be formed by an overflow down-draw method and the like.

Thus, when the glass of the present invention is used, a tempered glass substrate having high mechanical strength can be manufactured at low cost.

Further, because the method of producing a tempered glass of the present invention uses a glass having a high ion exchange performance and excellent denitrification resistance, a tempered glass substrate having high mechanical strength can be manufactured at low cost.

### BEST MODE FOR CARRYING OUT THE INVENTION

The tempered glass of the present invention has a compression stress layer on a surface thereof. The method of forming the compression stress layer on the surface of a glass includes a physical tempering method and a chemical tempering method. For the tempered glass of the present invention, it is preferable to form a compression stress layer by a chemical tempering method. The chemical tempering method is a method of introducing alkali ions having large ion radius into the surface of a glass substrate by ion exchange at a temperature lower than a strain point of the glass. When a compression stress layer is formed by the chemical tempering method, the tempering treatment can be performed successfully even if the thickness of the glass is small, and desired mechanical strength can be obtained. Further, even if the glass is cut after the formation of a compression stress layer on the glass, the glass is not broken easily unlike a glass tempered by a physical tempering method such as an air-cooling tempering method.

The conditions for ion exchange are not particularly limited, and may be determined in view of the viscosity property and the like of a glass. In particular, it is preferred that a K ion in a KNO₃ molten salt be ion-exchanged for a Na component in a glass substrate, because a compression stress layer can be formed efficiently on the surface of the glass substrate.

The reason for limiting the glass composition to the above-mentioned range in the tempered glass substrate of the present invention is illustrated below.

SiO₂ is a component forming a network of a glass, and the content thereof is 40 to 80%, preferably 45 to 80%, 55 to 75%, or 60 to 75%, andparticularlypreferably 60 to 70% . When the content of SiO₂ is too large, melting and forming of the glass become difficult, the thermal expansion coefficient becomes small, and matching of the thermal expansion coefficient with those of peripheral materials becomes difficult. On the other hand, when the content of SiO₂ is too small, glass formation becomes difficult. Further, the thermal expansion coefficient of the glass becomes large, and the thermal shock resistance of the glass tends to lower.

Al₂O₃ is a component enhancing an ion exchange performance. It also has an effect of enhancing the strain point and the Young's modulus of a glass, and the content thereof is 5 to 15%. When the content of Al₂O₃ is too large, a devitrified crystal tends to deposit in the glass and forming by an overflow down-draw method and the like becomes difficult. Further, the thermal expansion coefficient of the glass becomes too small, and matching of the thermal expansion coefficient with those of peripheral materials becomes difficult, and the viscosity of the glass rises, and it becomes difficult to melt the glass. When the content of Al₂O₃ is too small, there occurs a possibility of no manifestation of a sufficient ion exchange performance. Thus the suitable range of Al₂O₃ is preferably 7 to 11%, more preferably 8 to 11%, still more preferably 8 to 10%, and particularly preferably 8 to 9%.

B₂O₃ has an effect of lowering viscosity and density of glass and an effect of improving the ion exchange performance of a glass, in particular, the compression stress value of the glass. Further, B₂O₃ stabilizes the glass for a crystal to be unlikely precipitated, and hence, B₂O₃ has an effect of lowering the liquidus temperature of the glass. However, the excessive content of B₂O₃ is not preferred, because coloring on the surface of the glass called “Weathering” may generate by an ion exchange, water resistance of the glass may be reduced, and the depth of a compression stress layer may be decreased. Thus, the content of B₂O₃ is 0 to 8%, preferably 0 to 5%, more preferably 0 to 3%, still more preferably 0 to 2%, and particularly preferably 0 to 1%.

Li₂O is an ion exchange component, and is also a component lowering the viscosity of a glass to improve the meltability and the formability thereof. Further, Li₂O is a component improving the Young' s modulus of the glass. Further, Li₂O has a high effect of enhancing the compression stress value in an alkali metal oxide. However, when the content of Li₂O is too large, the liquidus viscosity lowers and the glass tends to be devitrified. Further, the thermal expansion coefficient of the glass increases too much, and hence, the thermal shock resistance of the glass lowers, and matching of the thermal expansion coefficient with those of peripheral materials becomes difficult. Further, when the low temperature viscosity is lowered too much to cause a possibility that stress relaxation occurs easily, the compression stress value decreases adversely in some cases. Therefore, the content of LiO₂ is 0 to 10%, and further, it is preferably 0 to 5%, 0 to 1%, 0 to 0.5%, or 0 to 0.1%, and substantially no content, namely, suppression to less than 0.01% is most preferred.

Na₂O is an ion exchange component, and has an effect of lowering the viscosity of a glass to improve the meltability and the formability thereof. Further, Na₂O is also a component improving the denitrification resistance of the glass. The content of Na₂O is 5 to 20%, and more suitable content thereof is 8 to 20%, 8.5 to 20%, 10 to 18%, 10 to 16%, 11 to 16%, or 12 to 16%, and particularly 13 to 16%. When the content of Na₂O is too large, the thermal expansion coefficient of the glass becomes too large, and hence, the thermal shock resistance of the glass lowers, and matching of the thermal expansion coefficient with those of peripheral materials becomes difficult. Further, there are tendencies that the strain point lowers too much, and a balance of the glass composition is lacking, thereby deteriorating the devitrification resistance of the glass. On the other hand, when the content of Na₂O is small, meltability deteriorates, the thermal expansion coefficient becomes small, and besides, the ion exchange performance deteriorates.

K₂O has an effect of promoting ion exchange, and shows a high effect of enlarging the depth of a compression stress layer, among alkali metal oxides. Further, K₂O has an effect of lowering viscosity of a glass to enhance its meltability and the formability. K₂O is also a component improving devitrification resistance. However, when the content of K₂O is too large, the thermal expansion coefficient of the glass becomes large, the thermal shock resistance of the glass lowers, and matching of the thermal expansion coefficient with those of peripheral materials becomes difficult. Further, there are tendencies that the strain point lowers too much, and a balance of the glass composition is lacking, thereby deteriorating the devitrification resistance of the glass. Thus, the content thereof is 0.5 to 20%, preferably 0.5 to 8%, 1 to 7.5%, 2 to 7.5%, or 3 to 7.5%, and particularly preferably 3.5 to 7.5%.

MgO is a component which lowers the viscosity of a glass to enhance the meltability and the formability, or to enhance the strain point and the Young's modulus, and shows a high effect of improving the ion exchange performance, among alkaline earth metal oxides. However, when the content of MgO becomes large, the density and the thermal expansion coefficient of the glass increase, and the glass tends to be devitrified. Therefore, it is desired that the content thereof be 0 to 10%, 0 to 6%, or 0 to 4%.

Further, the present invention is characterized in that the total content of Al₂O₃ and MgO is 8 to 16.5%. The ion exchange performance of a glass deteriorates when the total content decreases. In contrast, the devitrification resistance of a glass deteriorates and the formability decreases when the total content increases. Therefore, the total content is preferably 8 to 16%, and more preferably 8 to 14%.

Further, the present invention is characterized in that, in terms of a molar ratio, a (Li₂O+Na₂O+K₂O/Al₂O₃ ratio is 1.4 to 3, and an Na₂O/Al₂O₃ ratio is 1 to 3. That is, the devitrification resistance of a glass can be effectively improved when those ratios are within the range of 1.4 to 3. Note that the range of the (Li₂O+Na₂O+K₂O/Al₂O₃ ratio is more preferably 1.5 to 2.5, and still more preferably 1.8 to 2.5. In addition, the range of the Na₂O/Al₂O₃ ratio is more preferably 1.2 to 3, and still more preferably 1.2 to 2.5.

Further, the present invention is characterized in that an MgO/Al₂O₃ ratio is 0 to 1. The devitrification resistance deteriorates when the ratio exceeds 1. The preferred range of the MgO/Al₂O₃ ratio is 0 to 0.7, and in particular, 0 to 0.5.

Further, the present invention is substantially free of As₂O₃, PbO, and F in consideration of the environment. Here, “is substantially free of” means that the components are not actively used as raw materials and are contained at a level of impurities. The content thereof is less than 0.1%.

The tempered glass substrate of the present invention is constituted of the above-mentioned components. However, the following components can be added in a range not deteriorating the property of the glass.

CaO is a component which lowers the viscosity of a glass to enhance the meltability and the formability, or to enhance the strain point and the Young's modulus, and shows a high effect of improving the ion exchange performance, among alkaline earth metal oxides. The content of CaO is 0 to 6%. However, when the content of CaO becomes large, the density and the thermal expansion coefficient of a glass increase, and the glass tends to be devitrified, and in addition, the ion exchange performance tends to deteriorate in some cases. Therefore, it is desired that the content thereof be 0 to 5%, and in particular, 0 to 4%.

MgO+CaO is preferably 0 to 7%. When the content thereof is more than 7%, although the ion exchange performance of a glass is improved, the denitrification resistance of a glass deteriorates and the density and thermal expansion coefficient become too high. The preferred range thereof is 0 to 6%, 0 to 5%, or 0 to 4%, and in particular, 0 to 3%.

SrO and BaO are components which lower the viscosity of a glass to enhance the meltability and the formability, or to enhance the strain point and the Young's modulus, and each content thereof is preferably 0 to 6%. The ion exchange reaction is inhibited when the content thereof exceeds 6%. Further, the density and thermal expansion coefficient of a glass becomes high, and the glass becomes more susceptible to denitrification. The preferred content of SrO is 0 to 3%, 0 to 1.5%, 0 to 1%, or 0 to 0.5%, and in particular, 0 to 0.2%. Further, the preferred content of BaO is 0 to 3%, 0 to 1.5%, 0 to 1%, or 0 to 0.5%, and in particular, 0 to 0.2%.

In the present invention, by limiting the total content of SrO and BaO to 0 to 6%, the ion exchange performance can be improved more effectively. The preferred total content is 0 to 3%, 0 to 2.5%, 0 to 2%, or 0 to 1%, and in particular, 0 to 0.2%.

TiO₂ is a component having an effect of improving the ion exchange performance. Further, it has an effect of lowering the viscosity of a glass. However, when the content thereof becomes too large, the glass is colored and easily devitrifies. Therefore, the content thereof is 0 to 3%, preferably 0 to 1%, 0 to 0.8%, or 0 to 0.5%, and particularly preferably 0 to 0.1%.

ZrO₂ has an effect of significantly improving the ion exchange performance while increasing the viscosity and strain point near the liquidus viscosity of a glass, but devitrification resistance significantly deteriorates when the content thereof becomes too large. Therefore, the content thereof is 0 to 10%, preferably 0 to 5%, 0 to 3%, 0.001 to 3%, 0.1 to 3%, 1 to 3%, and particularly preferably 1.5 to 3%.

ZrO₂ and TiO₂ are desirably incorporated at a total content of 0.1 to 15% in view of improving the ion exchange performance in the present invention. A reagent may be used as a TiO₂ source and ZrO₂ source, or ZrO₂ and TiO₂ may be incorporated as impurities contained in raw materials and the like.

Further, when the content of an alkali metal oxide R₂O (R represents one kind or more selected from Li, Na, and K) becomes too large, a glass becomes more susceptible to devitrification, and in addition, because the thermal expansion coefficient of the glass is excessively high, the thermal shock resistance of the glass lowers, and matching of the thermal expansion coefficient with those of peripheral materials becomes difficult. In addition, the strain point of a glass may decrease excessively, resulting in difficulty in obtaining a high compression stress value in some cases. Further, the viscosity near the liquidus temperature may decrease, resulting in difficulty in ensuring a high liquidus viscosity in some cases. On the other hand, the ion exchange performance and meltability of a glass deteriorates when the total content of R₂O is too small. Therefore, the desirable content of R₂O is 10 to 25%, preferably 13 to 22%, more preferably 15 to 20%, and particularly preferably 16.5 to 20%.

Further, the range of a molar ratio of K₂O/Na₂O is preferably 0.1 to 0.8. The depth of a compression stress layer is likely to decrease when the ratio is less than 0.1. The obtained compression stress value is likely to decrease and a composition may become unbalanced resulting in increased susceptibility to devitrification when the ratio is more than 1. The molar ratio of K₂O/Na₂O is desirably limited within the ranges of 0.2 to 0.8, 0.2 to 0.5, and 0.2 to 0.4.

When the amount of alkaline earth metal oxides R′O (R′ represents one kind or more selected from Mg, Ca, Sr, and Ba) become large, the density and the thermal expansion coefficient of a glass increase, and the devitrification resistance deteriorates, and in addition, there is a tendency that the ion exchange performance deteriorates. Therefore, the total content of the alkaline earth metal oxides R′O is 0 to 10%, preferably 0 to 8%, more preferably 0 to 7%, still more preferably 0 to 6%, and most preferably 0 to 4%.

ZnO is a component which enhances the ion exchange performance of a glass, and in particular, has a high effect of enhancing the compression stress value. Further, the component has an effect of lowering the viscosity of a glass without lowering its low temperature viscosity. However, when the content of ZnO becomes large, there are tendencies that the glass manifests phase separation, the devitrification property deteriorates, the density becomes high, and the thickness of the compression stress layer becomes small. Therefore, the content thereof is 0 to 6%, preferably 0 to 5%, more preferably 0 to 3%, and still more preferably 0 to 1%.

Further, there appears a tendency that the devitrification resistance of a glass deteriorates when a value obtained by dividing the total content of R′O by the total content of R₂O becomes large. Therefore, the R′O/R₂O value is desirably limited to 0.5 or less, 0.3 or less, and 0.2 or less, in terms of mass fraction.

Further, SnO₂ acts as a fining agent of a glass while having an effect of further improving the ion exchange performance. However, there are tendencies that devitrification occurs attributing to SnO₂ and the glass is easily colored when the content thereof is large. Therefore, the desirable content of SnO₂ is 0.01 to 6%, 0.01 to 3%, and in particular, 0.1 to 1%.

P₂O₅ is a component which enhances the ion exchange performance of a glass, and in particular, shows a high effect of increasing the thickness of the compression stress layer, and hence, P₂O₅ can be incorporated up to 10%. However, when the content of P₂O₅ becomes large, the glass manifests phase separation, and the water resistance lowers, and thus, it is desired that the content thereof be 0 to 10%, 0 to 3%, or 0 to 1%, and in particular, 0 to 0.5%.

Further, as the fining agent, one or more kinds selected from the group consisting of As₂O₃, Sb₂O₃, CeO₂, SnO₂, F, Cl, and SO₃ may be contained in an amount of 0 to 3%. It is necessary to refrain as much as possible from the use of As₂O₃ and F, in consideration of the environment, and each component is not substantially contained in the present invention. Therefore, the content of a preferred fining agent of the present invention is, in terms of SnO₂+CeO₂+Cl, 0.001 to 1%, preferably 0.01 to 0.5%, and more preferably 0.05 to 0.4%.

Further, as mentioned above, SnO₂ also has an effect of improving the ion exchange performance, and hence, the glass desirably contains 0.01 to 6%, preferably 0.01 to 3%, and more preferably 0.1 to 1% of SnO₂, in order to simultaneously achieve a fining effect and an ion exchange performance improving effect. Meanwhile, a coloration of a glass may occur when SnO₂ is used as a fining agent, and hence, it is desirable to use, as a fining agent, 0.01 to 5% and preferably 0.01 to 3% of Sb₂O₃, or 0.001 to 5% and preferably 0.001 to 3% of SO₃, when improving the meltability while suppressing the coloration of a glass is required. Further, the coloration of a glass can be suppressed while improving the ion exchange performance by allowing SnO₂, Sb₂O₃, and SO₃ to coexist, and an appropriate content of SnO+Sb₂O₃+SO₃ is 0.001 to 10%, and preferably 0.01 to 5%.

Further, rare earth oxides such as Nb₂O₅ and La₂O₃ are components enhancing the Young's modulus of a glass. However, the cost of the raw material itself is high, and when the rare earth oxides are contained in a large amount, the denitrification resistance deteriorates. Therefore, it is desirable that the content thereof is limited to 3% or less, 2% or less, 1% or less, or 0.5% or less, and in particular, to 0.1% or less.

Note that, in the present invention, transition metal elements causing intense coloration of a glass, such as Co and Ni, are not preferred, because they lower the transmittance of a glass substrate. In particular, in the case of using the glass substrate for a touch panel display, when the content of the transition metal elements is large, the visibility of the touch panel display is deteriorated. Specifically, it is desirable that the use amount of raw materials or cullet be adjusted so that the content is 0.5% or less or 0.1% or less, and in particular, 0.05% or less.

Further, it is necessary to refrain as much as possible from the use of substances such as PbO and Bi₂O₃ in consideration of the environment, and PbO is not substantially contained in the present invention.

In the tempered glass substrate of the present invention, the suitable content range of each component can be appropriately selected to attain a preferred glass composition range. Of those, more suitable glass composition ranges are exemplified.

(1) The tempered glass substrate of the present invention is characterized in that the glass contains, in terms of mol %, 50 to 80% of SiO₂, 8 to 10.5% of Al₂O₃, 0 to 3% of B₂O₃, 0 to 4% of Li₂O, 8 to 20% of Na₂O, 1 to 7.5% of K₂O, 0 to 6% of CaO, 0 to 6% of MgO, 0 to 6% of SrO, 0 to 6% of BaO, 0 to 6% of ZnO, 8 to 16.5% of Al₂O₃+MgO, and 0 to 7% of CaO+MgO, has, in terms of a molar ratio, a (Li₂O+Na₂O+K₂O)/Al₂O₃ ratio of 1.5 to 2.5, an Na₂O/Al₂O₃ ratio of 1.2 to 3, an MgO/Al₂O₃ ratio of 0 to 1, and a K₂O/Na₂O ratio of 0.2 to 0.8, and is substantially free of As₂O₃, PbO, F, and BaO.

(2) The tempered glass substrate of the present invention is characterized in that the glass contains, in terms of mol %, 55 to 75% of SiO₂, 8 to 10% of Al₂O₃, 0 to 2% of B₂O₃, 0 to 4% of Li₂O, 8.5 to 20% of Na₂O, 3.5 to 7.5% of K₂O, 0 to 6% of MgO, 0 to 6% of CaO, 0 to 1.5% of SrO, 0 to 1.5% of BaO, 0 to 1% of ZnO, 0 to 0.8% of TiO₂, 0 to 3% of ZrO₂, 8 to 16% of MgO30 Al₂O₃, and 0 to 7% of MgO+CaO, has, in terms of a molar ratio, a (Li₂O+Na₂O+K₂O)/Al₂O₃ ratio of 1.8 to 2.5, an Na₂O/Al₂O₃ ratio of 1.2 to 3, an MgO/Al₂O₃ ratio of 0 to 1, and a K₂O/Na₂O ratio of 0.2 to 0.5, and is substantially free of As₂O₃, PbO, F, and BaO.

(3) The tempered glass substrate of the present invention is characterized in that the glass contains, in terms of mol %, 55 to 75% of SiO₂, 8 to 10% of Al₂O₃, 0 to 2% of B₂O₃, 0 to 4% of Li₂O, 10 to 16% of Na₂O, 3.5 to 7.5% of K₂O, 0 to 4% of MgO, 0 to 4% of CaO, 0 to 1% of SrO, 0 to 1% of BaO, 0 to 1% of ZnO, 0 to 0.5% of TiO₂, 0 to 3% of ZrO₂, 0 to 1% of P₂O₅, 8 to 14% of MgO+Al₂O₃, and 0 to 3% of MgO+CaO, has, in terms of a molar ratio, a (Li₂O+Na₂O+K₂O) /Al₂O₃ ratio of 1.8 to 2.5, an Na₂O/Al₂O₃ ratio of 1.2 to 3, an MgO/Al₂O₃ ratio of 0 to 0.5, and a K₂O/Na₂O ratio of 0.2 to 0.4, and is substantially free of As₂O₃, PbO, F, and BaO.

(4) The tempered glass substrate of the present invention is characterized in that the glass contains, in terms of mol %, 55 to 75% of SiO₂, 8 to 10% of Al₂O₃, 0 to 2% of B₂O₃, 0 to 4% of Li₂O, 11 to 16% of Na₂O, 3.5 to 7.5% of K₂O, 0 to 4% of MgO, 0 to 3% of CaO, 0 to 0.5% of SrO, 0 to 0.5% of BaO, 0 to 1% of ZnO, 0 to 0.5% of TiO₂, 0 to 3% of ZrO₂, 0 to 1% of P₂O₅, 0.01 to 2% of SnO₂, 8 to 14% of MgO+Al₂O₃, and 0 to 3% of MgO+CaO, has, in terms of a molar ratio, a (Li₂O+Na₂O+K₂O) /Al₂O₃ ratio of 1.8 to 2.5, an Na₂O/Al₂O₃ ratio of 1.2 to 2.5, an MgO/Al₂O₃ ratio of 0 to 0.5, and a K₂O/Na₂O ratio of 0.2 to 0.4, and is substantially free of As₂O₃, PbO, F, and BaO.

(5) The tempered glass substrate of the present invention is characterized in that the glass contains, in terms of mol %, 40 to 80% of SiO₂, 5 to 15% of Al₂O₃, 0 to 8% of B₂O₃, 0 to 10% of Li₂O, 5 to 20% of Na₂O, 0.5 to 20% of K₂O, 0 to 10% of MgO, 8 to 16.5% of Al₂O₃+MgO, and 0.01 to 5% of Sb₂O₃, has, in terms of a molar ratio, a (Li₂O+Na₂O+K₂O) /Al₂O₃ ratio of 1.4 to 3, an Na₂O/Al₂O₃ ratio of 1 to 3, and an MgO/Al₂O₃ ratio of 0 to 1, and is substantially free of As₂O₃, PbO, and F.

(6) The tempered glass substrate of the present invention is characterized in that the glass contains, in terms of mol %, 40 to 80% of SiO₂, 5 to 15% of Al₂O₃, 0 to 8% of B₂O₃, 0 to 10% of Li₂O, 5 to 20% of Na₂O, 0.5 to 20% of K₂O, 0 to 10% of MgO, 8 to 16.5% of Al₂O₃+MgO, and 0.001 to 5% of SO₃, has, in terms of a molar ratio, a (Li₂O+Na₂O+K₂O)/Al₂O₃ ratio of 1.4 to 3, an Na₂O/Al₂O₃ ratio of 1 to 3, and an MgO/Al₂O₃ ratio of 0 to 1, and is substantially free of As₂O₃, PbO, and F.

(7) The tempered glass substrate of the present invention is characterized in that the glass contains, in terms of mol %, 45 to 80% of SiO₂, 8 to 12% of Al₂O₃, 0 to 8% of B₂O₃, 0 to 10% of Li₂O, 5 to 20% of Na₂O, 0.5 to 20% of K₂O, 0 to 6% of CaO, 0 to 6% of MgO, 8 to 16.5% of Al₂O₃+MgO, 0 to 7% of CaO+MgO, and 0.001 to 10% of SnO₂+Sb₂O₃+SO₃, has, in terms of amolar ratio, a (Li₂O+Na₂O+K₂O)/Al₂O₃ ratio of 1.4 to 3, an Na₂O/Al₂O₃ ratio of 1 to 3, an MgO/Al₂O₃ ratio of 0 to 1, and a K₂O/Na₂O ratio of 0.1 to 0.8, and is substantially free of As₂O₃, PbO, and F.

The tempered glass of the present invention preferably satisfies the following properties.

The tempered glass of the present invention has the above-mentioned glass composition and has a compression stress layer on the glass surface. The compression stress of the compression stress layer is 300 MPa or more, preferably 400 MPa or more, more preferably 500 MPa or more, still more preferably 600 MPa or more, and still more preferably 900 MPa or more . The larger the compression stress is, the greater the mechanical strength of a glass substrate is. On the other hand, when extremely large compression stress is formed on the surface of the glass substrate, there is a possibility that micro cracks are generated on the substrate surface, which may lead to decrease in the strength of the glass. Because there is a possibility that the tensile stress present in the glass substrate becomes extremely high, the compression stress is preferably set to be 2000 MPa or less. In order to increase the compression stress, it may be advantageous to increase the content of Al₂O₃, TiO₂, ZrO₂, MgO, or ZnO, or to decrease the content of SrO or BaO. Alternatively, it may be advantageous to shorten the time necessary for ion exchange, or to decrease the temperature of an ion exchange solution.

The depth of a compression stress layer is preferably 10 μm or more, more preferably 15 μm or more, 20 μm or more, or 30 μm or more, and most preferably 40μor more. The larger the depth of a compression stress layer is, the more difficult it is that the glass substrate is cracked even if the glass substrate has a deep flaw, and the smaller the variation in the mechanical strength of the glass substrate becomes. On the other hand, it becomes difficult to cut the glass substrate, and hence, it is preferred that the depth of the compression stress layer be 500 μm or less. In order to increase the depth of the compression stress layer, it may be advantageous to increase the content of K₂O or P₂O₅, or to decrease the content of SrO or BaO. Further, it may be advantageous to elongate the time necessary for ion exchange, or to raise the temperature of an ion exchange solution.

The tempered glass of the present invention preferably has an average breaking stress of 300 MPa or more and a Weibull coefficient of 15 or more.

It is preferred that the tempered glass substrate of the present invention have a plate thickness of 3.0 mm or less, 1.5 mm or less, 0.7 mm or less, or 0.5 mm or less, and in particular, 0.3 mm or less. When the plate thickness of the glass substrate is smaller, the weight of the glass substrate can be reduced more. The tempered glass substrate of the present invention has a merit that even if the plate thickness is decreased, the glass substrate is not broken easily. It is advantage to perform forming of the glass by an overflow down-draw method, because the thickness reduction of the glass can be attained without polishing or the like.

The tempered glass substrate of the present invention preferably has an unpolished surface, and the average surface roughness (Ra) of the unpolished surface is 10 Å or less, preferably 5 Å or less, and more preferably 2 Å or less. Note that the average surface roughness (Ra) of the surface may be measured by a method according to SEMI D7-97 “Measurement method of surface roughness of FPD glass substrate”. The theoretical strength of glass is essentially very high, but breakage often occurs even with a stress which is by far lower than the theoretical strength. This phenomenon occurs because a small defect called Griffith flaw is generated on the surface of a glass substrate after forming of the glass, for example, in a polishing process. Therefore, when the surface of the tempered glass substrate is not polished, the original mechanical strength of the glass substrate is hardly impaired, and the glass substrate is not broken easily. Further, when the surface of the glass substrate is not polished, a polishing process can be omitted in the glass substrate production process, and thus, the production cost of the glass substrate can be decreased. In the tempered glass substrate of the present invention, if the both surfaces of a glass substrate are not polished, the glass substrate becomes more difficult to break. In the tempered glass substrate of the present invention, a chamfering process and the like may be performed on a cut surface of the glass substrate to prevent breakage occurring from the cut surface of the glass substrate. In order to obtain the unpolished surface, it may be advantageous to carry out forming of the glass by an overflow down-draw method.

In the tempered glass substrate of the present invention, the liquidus temperature of the glass is preferably 1075° C. or lower, 1050° C. or lower, 1030° C. or lower, 1010° C. or lower, 1000° C. or lower, 950° C. or lower, or 900° C. or lower, and particularly preferably 860° C. or lower. Here, a glass is ground, and a glass powder passing through a standard sieve of 30 mesh (mesh opening 500 μm) and remaining on 50 mesh (mesh opening 300 μm) is placed in a platinum boat, and is kept in a temperature gradient furnace for 24 hours, and then, the crystal thereof deposits, and the temperature at this stage is referred to as “liquidus temperature”. Note that, in order to decrease the liquidus temperature, it may be advantageous to increase the content of Na₂O, K₂O, or B₂O₃, or to decrease the content of Al₂O₃, Li₂O, MgO, ZnO, TiO₂, or ZrO₂.

In the tempered glass substrate of the present invention, the liquidus viscosity of the glass is preferably 10^{4.0} dPa·s or more, more preferably 10^{4.6} dPa·s or more, still more preferably 10^{5.0} dPa·s or more, particularly preferably 10^{5.6} dPa·s or more, and most preferably 10^{5.8} dPa·s or more. Here, “liquidus viscosity” denotes the viscosity of a glass at the liquidus temperature. Note that, in order to increase the liquidus viscosity, it may be advantageous to increase the content of Na₂O or K₂O, or to decrease the content of Al₂O₃, Li₂O, MgO, ZnO, TiO₂, or ZrO₂.

Note that when the liquidus viscosity is higher and the liquidus temperature is lower, the denitrification resistance of the glass is improved more and the formability of a glass substrate is improved more. When the liquidus temperature of a glass is 1,075° C. or lower and the liquidus viscosity of the glass is 10^{4.0} dPa·s or more, forming is possible by an overflow down-draw method.

The tempered glass substrate of the present invention has a glass density of preferably 2.7 g/cm or less, more preferably 2.55 g/cm³ or less, still more preferably 2.5 g/cm³ or less, and particularly preferably 2.43 g/cm³ or less. When the glass density is smaller, the weight of the glass substrate can be reduced more. Here, “density” denotes a value measured by a known Archimedes method. In order to lower the glass density, it may be advantageous to increase the content of SiO₂, P₂O₅, or B₂O₃, or to decrease the content of alkali metal oxides, alkaline earth metal oxides, ZnO, ZrO₂, or TiO₂.

The tempered glass substrate of the present invention has a glass thermal expansion coefficient in the temperature range of 30 to 380° C. of preferably 70 to 110×10⁻⁷/° C., more preferably 75 to 100×10⁻⁷/° C., still more preferably 80 to 100×10⁻⁷/° C., and particularly preferably 85 to 96×10⁻⁷/° C. When the thermal expansion coefficient of a glass is set within the above-mentioned ranges, the thermal expansion coefficient thereof tends to match those of members such as metals and organic adhesives, and peeling of members such as metals and organic adhesives can be prevented. Here, “thermal expansion coefficient” denotes a value measured in the temperature range of 30 to 380° C. using a dilatometer. In order to increase the thermal expansion coefficient, it may be advantageous to increase the content of alkali metal oxides or alkaline earth metal oxides, and, conversely, in order to decrease the thermal expansion coefficient, it may be advantageous to decrease the content of alkali metal oxides or alkaline earth metal oxides.

The tempered glass substrate of the present invention has a strain point of preferably 400° C. or higher, more preferably 430° C. or higher, still more preferably 450° C. or higher, and still more preferably 490° C. or higher. When the strain point of a glass is higher, the heat resistance of the glass is improved more, and even if a thermal treatment is performed on the tempered glass substrate, the tempered layer does not disappear easily. When the strain point of the glass is high, stress relaxation does not occur easily during ion exchange, and thus, a high compression stress value can be obtained. In order to increase the strain point of a glass, it may be advantages to decrease the content of alkali metal oxides, or to increase the content of alkaline earth metal oxides, Al₂O₂, ZrO₂, or P₂O₅.

The tempered glass substrate of the present invention has a temperature corresponding to a glass viscosity of 10^{2.5} dPa·s of preferably 1650° C. or lower, more preferably 1610° C. or lower, still more preferably 1600° C. or lower, still more preferably 1500° C. or lower, and still more preferably 1450° C. or lower. The lower the temperature corresponding to a glass viscosity of 10^{2.5} dPa·s, the smaller the strain imposed on the production equipment of a glass such as a melting furnace, and the more the bubble quality of a glass substrate can be improved. That is, the lower the temperature corresponding to a glass viscosity of 10^{2.5} dPa·s, the lower the cost for producing a glass substrate. Note that, the temperature corresponding to a glass viscosity of 10^{2.5} dPa·s corresponds to a melting temperature of a glass, and the lower the temperature corresponding to a glass viscosity of 10^{2.5} dPa·s, the lower the temperature at which a glass can be melted. Note that, in order to lower the temperature corresponding to 10^{2.5}dPa·s, the content of alkali metal oxides, alkaline earth metal oxides, ZnO, B₂O₃, and TiO₂ may be increased, or the content of SiO₂ and Al₂O₃ may be decreased.

The tempered glass of the present invention preferably has a Young's modulus of 65 GPa or more, 69 GPa or more, 71 GPa or more, 75 GPa or more, and 77 GPa or more. A glass is less deflected when the Young's modulus is higher, and when used for a touch panel, for example, the deformation degree is small when the glass is pressed strongly with a pen and the like, and hence, there can be prevented a display failure caused by a glass contacting a liquid crystal device positioned behind the glass.

Further, the glass of the present invention is characterized in that the glass contains, in terms of mol %, 40 to 80% of SiO₂, 5 to 15% of Al₂O₃, 0 to 8% of B₂O₃, 0 to 10% of Li₂O, 5 to 20% of Na₂O, 0.5 to 20% of K₂O, 0 to 10% of MgO, and 8 to 16.5% of Al₂O₃+MgO, has, in terms of a molar ratio, a (Li₂O+Na₂O+K₂O)/Al₂O₃ ratio of 1.4 to 3, an Na₂O/Al₂O₃ ratio of 1 to 3, and an MgO/Al₂O₃ ratio of 0 to 1, and is substantially free of As₂O₃, PbO, and F, and is characterized in that preferably, the glass contains, in terms of mol %, 45 to 80% of SiO₂, 8 to 11% of Al₂O₃, 0 to 5% of B₂O₃, 0 to 10% of Li₂O, 5 to 20% of Na₂O, 0.5 to 8% of K₂O, 0 to 6% of CaO, 0 to 6% of MgO, 8 to 16.5% of Al₂O₃+MgO, and 0 to 7% of CaO+MgO, has, in terms of a molar ratio, a (Li₂O+Na₂O+K₂O) /Al₂O₃ ratio of 1.4 to 3, an Na₂O/Al₂O₃ ratio of 1 to 3, an MgO/Al₂O₃ ratio of 0 to 1, and a K₂O/Na₂O ratio of 0.1 to 0.8, and is substantially free of As₂O₃, PbO, and F.

The reason for limiting the glass composition to the above-mentioned ranges and the preferred ranges thereof in the glass of the present invention are the same as those for the tempered glass substrate described above, and thus, descriptions thereof are omitted here. Further, naturally, the glass of the present invention has the properties and effects of the tempered glass substrate described above.

After the glass of the present invention is subjected to ion exchange at 430° C. in a KNO₃ molten salt, the glass preferably has a compression stress of the surface of 300 MPa or more and a thickness of the compression stress layer of 10 μm or more, in addition, preferably has a compression stress of the surface of 500 MPa or more and a thickness of the compression stress layer of 30 μm or more, and more preferably has a compression stress of the surface of 600 MPa or more and a thickness of the compression stress layer of 40 μm or more. Note that, the conditions for obtaining such stress are a temperature of KNO₃ of 400 to 550° C., and an ion exchange treatment time of 2 to 10 hours, and preferably 4 to 8 hours. The glass of the present invention has the above composition, and hence, the compression stress layer can be made deeper while achieving a high compression stress value without the use of a mixed liquid of a KNO₃ solution and a NaNO₃ solution or the like.

The glass according to the present invention can be produced by placing a glass raw material which is prepared to have a glass composition within the above-mentioned composition range in a continuous melting furnace, melting the glass raw material by heating at 1500 to 1600° C., fining the resultant, feeding the resultant to a forming apparatus, and forming the molten glass into a plate shape, and gradually cooling the plate.

It is preferred to adopt an overflow down-draw method for forming. When a glass substrate is formed by the overflow down-draw method, a glass substrate which is not polished and has a good surface quality can be produced. The reason for this is that, in the case of adopting the overflow down-draw method, the surfaces to be the surfaces of the glass substrate does not come in direct contact with a trough-shaped refractory, and is formed in the form of free surface, and hence, a glass substrate which is not polished and has a good surface quality can be formed. Here, the overflow down-draw method is a method in which a glass in molten condition is allowed to overflow from both sides of a heat-resistant trough-shaped structure, and the overflown molten glasses are down-drawn downwardly while combining them at the lower end of the trough-shaped structure, to thereby produce a glass substrate. The structure and material of the tub-shaped structure are not particularly limited as long as they provide desired size and surface precision of the glass substrate and can realize quality usable in the glass substrate. Further, any method may be used to apply force to the glass substrate to perform downward down-draw. For example, there may be adopted a method involving rotating a heat resistant roll having sufficiently large width in the state of being in contact with a glass substrate, to thereby draw the glass substrate, and a method involving allowing several pairs of heat resistant rolls to come into contact with only end surfaces of the glass substrate to thereby draw the glass substrate. The glass of the present invention is excellent in denitrification resistance and has a viscosity property suitable for forming, and thus, forming by the overflow down-draw method can be carried out with good precision by using the glass of the present invention. Note that, when the liquidus temperature is 1075° C. or lower and the liquidus viscosity is 10^{4.0} dPa·s or more, a glass substrate can be produced by an overflow down-draw method.

Note that various methods other than the overflow down-draw method can be adopted. For example, various forming methods can be adopted, such as down-draw methods (a slot down method and a re-draw method), a float method, a roll out method, and a press method. For example, if a glass is formed by a press method, a small-sized glass substrate can be produced with good efficiency.

For producing the tempered glass substrate of the present invention, first, the above-mentioned glass is prepared. Next, a tempering treatment is performed. The glass substrate may be cut into a given size before the tempering treatment, but it is preferred to perform the cutting after the tempering treatment, because the production cost can be reduced. It is desirable that the tempering treatment be performed by an ion exchange treatment. The ion exchange treatment can be performed, for example, by immersing a glass plate in a potassium nitrate solution at 400 to 550° C. for 1 to 8 hours. Optimum ion exchange conditions may be selected in view of the viscosity property, applications, and plate thickness of glass, internal tensile stress in glass, and the like.

### Example 1

The present invention is hereinafter described based on examples.

Tables 1 to 3 show the glass compositions and properties of examples of the present invention (sample Nos. 1 to 12). Note that, in the tables, the expression “none” means “not measured”.

TABLE 1

| | No. 1 | No. 2 | No. 3 | No. 4 | No. 5 |
|---|---|---|---|---|---|
| SiO₂ | 70.9 | 73.9 | 73.8 | 67.6 | 66.1 |
| Al₂O₃ | 9.7 | 8.7 | 8.7 | 8.5 | 8.5 |
| ZnO | | | | 1.5 | 3.0 |
| Na₂O | 9.7 | 13.0 | 8.7 | 8.5 | 8.5 |
| Li₂O | 4.8 | | | 4.1 | 4.1 |
| K₂O | 4.8 | 4.3 | 8.7 | 3.7 | 3.7 |
| Sb₂O₃ | | | | | |
| ZrO₂ | | | | | |
| TiO₂ | | | | | |
| B₂O₃ | | | | | |
| MgO | | | | 6.0 | 6.0 |
| CaO | | | | | |
| SnO₂ | 0.1 | 0.1 | 0.1 | 0.1 | 0.1 |
| Density (g/cm³) | 2.42 | 2.41 | 2.41 | 2.46 | 2.50 |
| Ps (° C.) | 455 | 491 | 497 | 493 | 495 |
| Ta (° C.) | 499 | 538 | 545 | 538 | 540 |
| Ts (° C.) | 722 | 775 | 791 | 768 | 762 |
| 10⁴ (° C.) | 1136 | 1215 | 1249 | 1156 | 1138 |
| 10³ (° C.) | 1370 | 1456 | 1494 | 1363 | 1338 |
| 10^{2.5} (° C.) | 1517 | 1610 | 1650 | 1493 | 1466 |
| Thermal expansion | 96 | 91 | 93 | 88 | 89 |
| coefficient (×10⁻⁷/° C.) | | | | | |
| Liquidus | 940 | 882 | 967 | 1008 | 1038 |
| temperature (° C.) | | | | | |
| logηTL | 5.3 | 6.3 | 5.8 | 5.0 | 4.7 |
| Compression stress | 514 | 517 | 349 | 833 | 895 |
| (MPa) | | | | | |
| Stress depth (μm) | 31 | 42 | 57 | 17 | 15 |
| Young's modulus [GPa] | 74 | 69 | 67 | 77 | 77 |
| Rigidity ratio [GPa] | 31 | 29 | 28 | 32 | 32 |

TABLE 2

| | No. 6 | No. 7 | No. 8 | No. 9 | No. 10 |
|---|---|---|---|---|---|
| SiO₂ | 66.9 | 65.4 | 66.9 | 66.4 | 62.3 |
| Al₂O₃ | 8.5 | 8.5 | 8.4 | 8.6 | 8.4 |
| ZnO | 1.5 | 3.0 | | | |
| Na₂O | 8.5 | 8.5 | 11.6 | 7.6 | 16.0 |
| Li₂O | 4.1 | 4.1 | | | |
| K₂O | 3.7 | 3.7 | 4.2 | 7.5 | 3.5 |
| Sb₂O₃ | | | | | |
| ZrO₂ | | | 1.3 | 2.2 | 2.1 |
| TiO₂ | 0.7 | 0.7 | | | |
| B₂O₃ | | | 1.9 | 1.9 | 1.9 |
| MgO | 6.0 | 6.0 | 3.3 | 3.3 | 3.3 |
| CaO | | | 2.3 | 2.4 | 2.4 |
| SnO₂ | 0.1 | 0.1 | 0.1 | 0.1 | 0.1 |
| Density (g/cm³) | 2.47 | 2.51 | 2.49 | 2.50 | 2.54 |
| Ps (° C.) | 496 | 498 | 544 | 574 | 529 |
| Ta (° C.) | 540 | 541 | 589 | 623 | 570 |
| Ts (° C.) | 761 | 755 | 812 | 867 | 773 |
| 10⁴ (° C.) | 1140 | 1127 | 1205 | 1253 | 1122 |
| 10³ (° C.) | 1344 | 1325 | 1406 | 1447 | 1300 |
| 10^{2.5} (° C.) | 1473 | 1451 | 1534 | 1570 | 1417 |
| Thermal expansion | 89 | 89 | 90 | 89 | 100 |
| coefficient (×10⁻⁷/° C.) | | | | | |
| Liquidus | 1009 | 1032 | 945 | 1075 | 855 |
| temperature (° C.) | | | | | |
| logηTL | 4.9 | 4.6 | 6.0 | 5.3 | 6.4 |
| Compression stress | 845 | 902 | 819 | 638 | 837 |
| (MPa) | | | | | |
| Stress depth (μm) | 17 | 15 | 44 | 55 | 44 |
| Young's modulus [GPa] | 77 | 78 | None | None | None |
| Rigidity ratio [GPa] | 32 | 33 | None | None | None |

TABLE 3

| | No. 11 | No. 12 |
|---|---|---|
| SiO₂ | 77.1 | 73.9 |
| Al₂O₃ | 5.7 | 8.7 |
| ZnO | | |
| Na₂O | 8.6 | 4.3 |
| Li₂O | 4.3 | 4.3 |
| K₂O | 4.3 | 8.7 |
| Sb₂O₃ | | |
| ZrO₂ | | |
| TiO₂ | | |
| B₂O₃ | | |
| Mg0 | | |
| CaO | | |
| SnO₂ | | 0.1 |
| Density (g/cm³) | 2.39 | 2.40 |
| Ps (° C.) | 437 | 476 |
| Ta (° C.) | 482 | 523 |
| Ts (° C.) | 704 | 767 |
| 10⁴ (° C.) | 1114 | 1212 |
| 10³ (° C.) | 1348 | 1457 |
| 10^{2.5} (° C.) | 1501 | 1611 |
| Thermal expansion | 88 | 89 |
| coefficient | | |
| (×10⁻⁷/° C.) | | |
| Liquidus | 815 | 1013 |
| temperature (° C.) | | |
| logηTL | 6.2 | 5.2 |
| Compression stress | 325 | 324 |
| (MPa) | | |
| Stress depth (μm) | 36 | 39 |
| Young's modulus | 71 | 70 |
| [GPa] | | |
| Rigidity ratio | 30 | 30 |
| [GPa] | | |

Each of the samples in Tables 1 to 3 was produced as described below. First, glass raw materials were prepared so as to have glass compositions shown in the tables, and each of the raw materials was melted at 1580° C. for 8 hours using a platinum pot. Thereafter, the molten glass was cast on a carbon plate and formed into a plate shape. Various properties were evaluated for the resultant glass plate.

The density was measured by a known Archimedes method.

The strain point Ps and the annealing point Ta were measured based on a method of ASTM C336.

The softening point Ts was measured based on a method of ASTM C338.

Temperatures corresponding to glass viscosities 10^{4.0} dPa·s, 10^{3.0} dPa·s, and 10^{2.5} dPa·s were measured by a platinum sphere pull up method.

As the thermal expansion coefficient α, an average thermal expansion coefficient in the temperature range of 30 to 380° C. was measured using a dilatometer.

A glass was ground, and a glass powder passing through a standard sieve of 30 mesh (mesh opening 500 μm) and remaining on 50 mesh (mesh opening 300 μm) was placed in a platinum boat, and was kept in a temperature gradient furnace for 24 hours, and then, the crystal thereof deposited, and the temperature measured at this stage was referred to as liquidus temperature.

The liquidus viscosity shows the viscosity of each glass at the liquidus temperature.

The Young's modulus and rigidity ratio were measured by a resonance method.

As a result, the obtained glass substrate had a density of 2.54 g/cm³ or less, a thermal expansion coefficient of 88 to 100×10⁻⁷/° C., and thus, the glass substrate was suitable as a tempered glass substrate. The liquidus viscosity was as high as 10^{4.6} dPa·s or more and overflow down-draw forming is possible, and further, the temperature at 10^{2.5} dPa·s was as low as 1,650° C. or lower, and hence, it is supposed that a large amount of glass substrates can be supplied at low cost with high productivity. Note that the untempered glass substrate and tempered glass substrate are not substantially different in glass composition as the whole glass substrate, even though the glass compositions thereof are microscopically different on the surface of the glass substrate. Subsequently, both surfaces of each of the glass substrates were subjected to optical polishing, and then, an ion exchange treatment was performed while sample Nos. 1 to 7, 11, and 12 were immersed in a KNO₃ solution at 430° C. for 4 hours, and sample Nos. 8 to 10 were immersed in a KNO₃ solution at 460° C. for 6 hours. After completion of the treatment, the surface of each sample was washed, and then, a value of a surface compression stress and a depth of a compression stress layer were calculated from the number of interference stripes and clearance thereof observed using a surface stress meter (FSM-6000 manufactured by Toshiba Corporation). In calculation, the refractive index of a sample was 1.53, and the photoelastic constant was 28 [(nm/cm)/MPa].

As a result, in the glass substrates of sample Nos. 1 to 12 which are examples of the present invention, a compression stress of 324 MPa or more was generated on its surface, and its depth was as deep as 15 μm or more.

Note that, in the above-mentioned examples, a glass was melted, formed by casting, and then optically polished before the ion exchange treatment, for convenience of description of the present invention. In the case of production in industrial scale, it is preferred that a glass substrate be formed by an overflow down-draw method and the like, and an ion exchange treatment be carried out in the state that the both surfaces of the glass substrate are unpolished.

Further, test pieces having a dimension of 3 mm×4 mm×40 mm were prepared using the glass of Sample No. 7 and a three-point bending test was performed. Note that, the entire surface of each test piece was optically polished and chamfering was not performed. The test pieces were each immersed in a KNO₃ solution under the conditions of 460° C. for 8 hours and 490° C. for 8 hours to thereby perform an ion exchange treatment. After the ion exchange treatment, each test piece was washed under running water and then subjected to a three-point bending test. A breaking stress was calculated from a breaking load obtained by the test, and a Weibull coefficient was determined by performing Weibull-plotting by an average value ranking method. Table 4 shows the results. Note that, a three-point bending test was also performed with a glass test piece which has not been subjected to an ion exchange treatment (non-tempered product) for reference.

TABLE 4

| | Non-tempered | Tempered | Tempered |
|---|---|---|---|
| | product | product | product |
| Ion exchange temperature (° C.) | — | 460 | 490 |
| Ion exchange time (hour) | — | 8 | 8 |
| Average breaking stress (MPa) | 135 | 650 | 540 |
| Surface compression stress | — | 770 | 614 |
| (MPa) | | | |
| Stress depth (μm) | — | 31 | 50 |
| Weibull coefficient | 6 | 19 | 61 |

It can be understood from Table 4 that the tempered glass of the present invention has a high average breaking stress, a high Weibull coefficient, and a small variation in strength.

### INDUSTRIAL APPLICABILITY

The tempered glass substrate of the present invention is suitable as a glass substrate for a cover glass of a cellular phone, a digital camera, PDA, or the like, or for a touch panel display or the like. Further, the tempered glass substrate of the present invention can be expected to find used in applications requiring high mechanical strength, for example, window glasses, magnetic disk substrates, flat panel display substrates, cover glasses for solar cells, solid-state imaging device cover glasses, and tableware, in addition to the above-mentioned applications.

1. A tempered glass, which has a compression stress layer on a surface thereof, comprising, in terms of mol %, 40 to 80% of SiO₂, 5 to 15% of Al₂O₃, 0 to 8% of B₂O₃, 0 to 10% of Li₂O, 5 to 20% of Na₂O, 0.5 to 20% of K₂O, 0 to 10% of MgO, and 8 to 16.5% of Al₂O₃+MgO, wherein the glass has, in terms of a molar ratio, a (Li₂O+Na₂O+K₂O)/Al₂O₃ ratio of 1.4 to 3, an Na₂O/Al₂O₃ ratio of 1 to 3, and an MgO/Al₂O₃ ratio of 0 to 1, and is substantially free of As₂O₃, PbO, and F.

2. The tempered glass according to claim 1, which has a compression stress layer on a surface thereof, comprising, in terms of mol %, 45 to 80% of SiO₂, 8 to 11% of Al₂O₃, 0 to 5% of B₂O₃, 0 to 10% of Li₂O, 5 to 20% of Na₂O, 0.5 to 8% of K₂O, 0 to 6% of CaO, 0 to 6% of MgO, 8 to 16.5% of Al₂O₃+MgO, and 0 to 7% of CaO+MgO, wherein the glass has, in terms of a molar ratio, a (Li₂O+Na₂O+K₂O)/Al₂O₃ ratio of 1.4 to 3, an Na₂O/Al₂O₃ ratio of 1 to 3, an MgO/Al₂O₃ ratio of 0 to 1, and a K₂O/Na₂O ratio of 0.1 to 0.8, and is substantially free of As₂O₃, PbO, and F.

3. The tempered glass according to claim 1, comprising 0.01 to 6% of SnO₂.

4. The tempered glass according to claim 1, wherein an average breaking stress is 300 MPa or more, and a Weibull coefficient is 15 or more.

5. The tempered glass according to claim 1, wherein a compression stress of the surface is 300 MPa or more, and a depth of the compression stress layer is 10 μm or more.

6. A tempered glass substrate comprising the tempered glass according to claim 1.

7. The tempered glass substrate according to claim 6, wherein the tempered glass is formed into a plate shape by an overflow down-draw method.

8. The tempered glass substrate according to claim 6, wherein the tempered glass substrate has an unpolished surface.

9. The tempered glass substrate according to claim 6, wherein the tempered glass substrate has a liquidus temperature of 1075° C. or lower.

10. The tempered glass substrate according to claim 6, wherein the tempered glass substrate is formed of a glass having a liquidus viscosity of 10^{4.0} dPa·s or more.

11. The tempered glass substrate according to claim 6, which is used for a touch panel display.

12. The tempered glass substrate according to claim 6, which is used for a cover glass of a cellular phone.

13. The tempered glass substrate according to claim 6, which is used for a cover glass of a solar cell.

14. The tempered glass substrate according to claim 6, which is used as a protective member of a display.

15. A glass comprising, in terms of mol %, 40 to 80% of SiO₂, 5 to 15% of Al₂O₃, 0 to 8% of B₂O₃, 0 to 10% of Li₂O, 5 to 20% of Na₂O, 0.5 to 20% of K₂O, 0 to 10% of MgO, and 8 to 16.5% of Al₂O₃+MgO, wherein the glass has, in terms of a molar ratio, a (Li₂O+Na₂O+K₂O)/Al₂O₃ ratio of 1.4 to 3, an Na₂O/Al₂O₃ ratio of 1 to 3, and an MgO/Al₂O₃ ratio of 0 to 1, and is substantially free of As₂O₃, PbO, and F.

16. The glass according to claim 15, comprising 0.01 to 6% of SnO₂.

17. A method of producing a tempered glass substrate, comprising the steps of:
melting a glass raw material blended so as to have a glass composition comprising, in terms of mol %, 40 to 80% of SiO₂, 5 to 15% of Al₂O₃, 0 to 8% of B₂O₃, 0 to 10% of Li₂O, 5 to 20% of Na₂O, 0.5 to 20% of K₂O, 0 to 10% of MgO, and 8 to 16.5% of Al₂O₃+MgO, wherein the glass has, in terms of a molar ratio, a (Li₂O+Na₂O+K₂O)/Al₂O₃ ratio of 1.4 to 3, an Na₂O/Al₂O₃ ratio of 1 to 3, and an MgO/Al₂O₃ ratio of 0 to 1, and is substantially free of As₂O₃, PbO, and F;
forming the glass into a plate shape; and
subjecting the glass to an ion exchange treatment, to thereby form a compression stress layer on a surface of the glass.

18. The method of producing a tempered glass substrate according to claim 17, wherein the tempered glass substrate comprises 0.01 to 6% of SnO₂.

19. The method of producing a tempered glass substrate according to claim 17, wherein the glass is formed into a plate shape by a down-draw method.

20. The method of producing a tempered glass substrate according to claim 17, wherein the glass is formed into a plate shape by an overflow down-draw method.

21. The tempered glass according to claim 2, wherein an average breaking stress is 300 MPa or more, and a Weibull coefficient is 15 or more.

22. The tempered glass according to claim 2, wherein a compression stress of the surface is 300 MPa or more, and a depth of the compression stress layer is 10 μm or more.

23. A tempered glass substrate comprising the tempered glass according to claim 2.

24. The method of producing a tempered glass substrate according to claim 18, wherein the glass is formed into a plate shape by an overflow down-draw method.
